(19) United States
(12) Patent Application Publication
(10) Pub. No.: US 2026/0264290 A1
(43) Pub. Date: Sep. 10, 2026

(54) TILE SAWING MAT

(71) Applicant: TILLIE TOOLS BV, Nieuwpoort (BE)

(72) Inventor: Jurgen MEERSCH, Nieuwpoort (BE)

(21) Appl. No.: 19/489,225

(22) PCT Filed: Jun. 18, 2024
(86) PCT No.: PCT/IB2024/055923

§ 371 Date: Dec. 1, 2025

(30) Foreign Application Priority Data
Jun. 19, 2023 (BE) BE2023/5498

(51) Int. Cl. B28D 7/04; B28D 7/02

(52) U.S. Cl. CPC B28D 7/04; B28D 7/02

(57) ABSTRACT

Disclosed is a tile sawing mat suitable for supporting tile elements during the sawing thereof, including a flexible carrier having a first main surface and a multiplicity of flexible support structures connected to the carrier, wherein said support structures extend in a direction transverse to the first main surface, wherein the support structures are adapted in order to form, in use, a support surface for at least one tile element, and wherein said support structures have a height of 35 mm to 100 mm from the first main surface measured in a direction transverse to the first main surface

This application is a national phase entry under § 371 of International Application No. PCT/IB2024/055923, which claims the benefit of Belgian Patent Application No. BE2023/5498 filed on Jun. 19, 2023, each of which is hereby incorporated by reference in its entirety.

### FIELD OF THE DISCLOSURE

The present disclosure relates to a tile sawing mat, more specifically for use in the construction industry. The disclosure specifically relates in particular to a tile sawing mat in the form of a flexible mat which is suitable for supporting tile elements during the cutting or sawing thereof. In embodiments, the tile sawing mat described herein comprises a flexible carrier having a first main surface and a multiplicity of flexible support structures connected to the carrier, wherein said support structures extend in a direction transverse to the first main surface, and wherein the support structures are adapted in order to form, in use, a support surface for at least one tile element.

### BACKGROUND

When placing tiles as floor covering, it is sometimes necessary to adapt the size of the tiles to the dimensions and/or design of the installation site. Use is often made of a tile cutting machine for this. Such machines comprise a wide, circular blade with sand crystals or diamonds, in order to saw through a tile. Here, water is splashed onto the blade in order to keep dust formation under control, to cool the blade and to reduce friction during the cutting. Instead of splashing water directly onto the blade, use may be made of a tile cutting machine such as, inter alia, described in European patent publication EP 2 000 273 A2 and EP 2 000 272 A2. The tile cutting machine shown in EP 2 000 273 A2 and EP 2 000 272 A2 comprises a bath (tub) for receiving water and a tile which has to be cut therein. A cutting head assembly having a blade driven by a motor is positioned above a tile-supporting surface located in the container and is movable with respect thereto. Located in the container is a flexible holding mat comprising a number of raised nubs which extend perpendicularly from the surface of the holding mat and are provided to support a tile placed on the mat in question. The nubs ensure frictional grip on the bottom of a tile placed on the holding mat, as a result of which the cutting of the tile is simplified without a user needing to manually push the tile down when the tile is being cut by the blade of the cutting head assembly.

However, in some circumstances the use of a tile cutting machine is not the ideal solution because it is not possible to saw to a sufficient depth with such a machine. The removal of specific shapes from a tile element for particular applications, such as the provision of a circular opening in a tile for, for example, a shower tap, etc., is also not possible with such a tile cutting machine. In such cases, use is made of portable cutting tools which the fitter can use to saw tiles to the desired dimensions or to saw out specific shapes. A commonly used cutting tool, what is known as the grinding disc, uses a rotating saw blade with which a tile can be sawn. The sawing will be carried out at the construction site. It is often the case that this cutting work is performed under non-optimal conditions, since there is often not a suitable support structure on which the tiles to be sawn can be placed. This increases the probability of errors and sometimes also endangers the safety of the worker.

American patent publication US 2018/0017269 describes a universal tile installation mat, a so-called uncoupling mat, for use in the construction of tile floors and walls, the mat being fastened to a subfloor surface formed from wood or concrete or to a wall surface. The mat in question uncouples the mortar and the tiles placed therein and in this way prevents cracking of the mortar, the tiles and the joints as a result of displacements in the load-bearing surfaces. Such a mat is formed from flexible plastics materials and has three different kinds of support structures which are integrally formed therein in order to anchor mortar and to hold heating wires in different patterns as desired so as to form a heated tile floor or wall. The support structures facilitate the installation of heated wires and provide counteracting forces against the escape of a heating wire from the anchoring passages formed by the support structures. Such a tile installation mat is, however, not suitable as a tile sawing mat where tile elements have to be sufficiently supported during the cutting or sawing thereof because the installation mat in question, more specifically the different support structures, would be damaged during the cutting, as a result of which such an installation mat-when used as a tile sawing mat-would no longer be able to be used for its ultimate function, namely uncoupling mat.

### SUMMARY

It is an object of embodiments of the present invention is to provide an efficiently usable article of use (aid) which makes it possible to saw tiles in a practical and simple manner, preferably by means of a rotatable cutting device, preferably a cutting disc.

This object may be achieved by providing a tile sawing mat suitable for supporting tile elements during the sawing thereof, comprising a flexible carrier having a first main surface and a multiplicity of flexible support structures connected to the carrier, wherein said support structures extend in a direction transverse to the first main surface, wherein the support structures are adapted in order to form, in use, a support surface for at least one tile element, and wherein said support structures have a height of at least 35 mm from the first main surface, measured in a direction transverse to the first main surface, such that the first main surface is protected against damage during the sawing of tile elements. Said support structures preferably have a height of at most 100 mm from the first main surface, measured in a direction transverse to the first main surface. The support structures are preferably inseparably connected to the carrier. The various support structures are preferably arranged at a distance from each other. Changing the number and/or the stiffness of the support structures on the carrier makes it possible to change the load-bearing capability of the tile sawing mat.

Since the mat according to embodiments of the invention will predominantly be used for the sawing of tile elements, the present disclosure will predominantly refer to such sawing of tile elements by referring to the mat as a “tile sawing mat.” However, this terminology is not to be taken in a limiting sense and does not rule out any other possible applications and/or uses of the mat described herein that involve sawing other articles using, for instance, a portable cutting tool, such as, for example, the sawing of wooden panels or pieces of natural stone.

Such a tile sawing mat according to at least one embodiment of the invention makes it easy for a tile to be sawn to be sufficiently supported at a construction site so as to easily and rapidly saw said tile to the desired shape and/or to the desired size by means of a portable cutting tool, preferably a grinding disc. The height of the support structures is high enough that damage to the main surface by the rotating saw blade (cutting blade) of the cutting tool is avoided. The height of the support structures is selected in such a way that the mat in question is also suitable for use with a cutting tool whose saw blade has a greater diameter. In addition, due to their height and their mutual arrangement, the support structures ensure, in use, that there is enough space (i.e. the space located under a tile element provided on the support structures) for the temporary reception of the sawing waste.

In a preferred embodiment of the tile sawing mat according to the invention, said mat is manufactured from rubber. A skilled artisan will recognize that the mat may also be manufactured from another suitable flexible material, such as polyurethane.

In a more preferred embodiment of the tile sawing mat, said support structures have the same height. Support structures having the same height afford the advantage that a tile to be sawn will lie flat during the sawing thereof. In order to further improve the support, the top surface of the various support structures is preferably flat.

According to a particular embodiment of the tile sawing mat, said support structures are stepped or conical. Regardless of the embodiment, the base surface is greater than the top surface for each support structure in a preferred embodiment. A greater base surface provides better strength, whilst a smaller top surface reduces the risk of the support structures being damaged by a cutting tool.

In a more particular embodiment of the tile sawing mat according to the invention, the flexible mat comprises at least a first and second set of support structures, wherein each set comprises at least a number of rows of at least three support structures extending in a longitudinal direction, wherein the support structures of the same set are located at a mutual centre-to-centre distance of 25 to 35 mm from each other. Preferably, a free intermediate space at least 60 mm wide, preferably at least 65 mm wide, without support structures, is formed between said first and second set, which intermediate space forms a sawing zone. The sawing zone is a space created to prevent the support structures from being damaged by the cutting tool during use of the tile sawing mat. During use, it is important that the tile elements to be sawn are positioned on the support structures in such a way that the sawing line along which the tile element in question will be sawn through is located at a sawing zone of the tile sawing mat.

Preferably, said first and second set are arranged according to a repeating pattern on the carrier. In this way, the tile sawing mat comprises a number of sawing zones.

In a particularly advantageous embodiment of the tile sawing mat according to the invention, the flexible mat comprises an opening which is at least 20 cm wide. Preferably, the opening in question is 20 cm to 40 cm wide. The opening in question is preferably located centrally in the flexible mat. Said opening is configured to facilitate the sawing of special tile pieces and to prevent support structures from being damaged by a grinding disc during the sawing of the tile pieces in question.

Due to the continuously increasing need for a dust-free environment, the present invention provides, in a particularly advantageous embodiment, a tile sawing mat comprising one or more extraction openings through which dust, more specifically dust resulting from the sawing of tile elements on the tile sawing mat, can be discharged, preferably in the direction of an extraction installation. In a first preferred embodiment, the tile sawing mat is provided with a central extraction opening, preferably a circular opening having a diameter preferably of between 30 mm and 300 mm. In the present case, the central extraction opening takes the place of the above-described opening which is configured to facilitate the sawing of special tile pieces.

In a second preferred embodiment of the tile sawing mat according to the invention, the flexible carrier of the tile sawing mat is provided with passages through which dust, more specifically dust resulting from the sawing of tile elements on the tile sawing mat, can be discharged. Said passages are preferably perforations made in the flexible carrier having a diameter of preferably between 2 mm and 15 mm. The tile sawing mat may also comprise both a central extraction opening and said various passages.

The tile sawing mat according to at least one embodiment of the present invention is preferably able to be rolled up. This affords the advantage that it can be easily moved and stored.

In a more particular embodiment, in addition to the aforementioned openings, the tile sawing mat further comprises a second opening having such a design that it is suitable for receiving part of the hand of the user of the tile sawing mat in question, and therefore the latter can be easily grasped and moved.

The present disclosure also relates to a tile support device comprising a housing with a load-bearing structure and a tile sawing mat according to at least one embodiment of the invention, which is able to be placed on the load-bearing structure, as described in the present description and claims. The housing preferably comprises a bottom wall and upright side walls, wherein the load-bearing structure is formed by support edges extending transversely, or virtually transversely, with respect to the side walls. The tile support device is also provided with an extraction device which is connectable to said container and is fitted so as to extract the dust released during the sawing of tile elements. Such a tile support device affords the advantage that it is much more pleasant and healthier to operate for the user thereof.

### BRIEF DESCRIPTION OF THE DRAWINGS

In order to further illustrate the properties of the present invention and to indicate additional advantages and particular features thereof, a more detailed description of the tile sawing mat according to embodiments the invention will now be given. It will be clear that nothing in the following description may be interpreted as a limitation of the protection of the invention as laid down in the claims.

In the present description, reference numerals and letters are used to refer to the attached drawings, in which:

FIG. 1 is a perspective illustration of a possible embodiment of a tile sawing mat according to at least one embodiment of the invention;

FIG. 2 is a top view of the tile sawing mat shown in FIG. 1;

FIG. 3 is a front view of the tile sawing mat shown in FIG. 1;

FIG. 4 is a detail illustration of part of the tile sawing mat shown in FIG. 1.

The tile sawing mat (1) according to at least one embodiment of the invention is suitable for supporting articles, such as tile elements, bricks, etc., formed from a variety of materials, such as ceramic, porcelain, marble, etc., during the sawing or cutting thereof. The use of the tile sawing mat is not limited to use for support during the sawing of said articles, but is also suitable for supporting other articles which can also be sawn by means of a portable cutting tool, such as a cutting disc.

The mat (1) according to the present invention was specifically developed for use on a construction site, and this may be both an indoor and outdoor environment.

The tile sawing mat according to at least one embodiment of the invention preferably has a square design and has dimensions of preferably: 55 cm×55 cm to 120 cm×120 cm. A skilled artisan will recognize that the mat (1) may also have dimensions that differ therefrom or a different design, such as rectangular, circular, oval, etc.

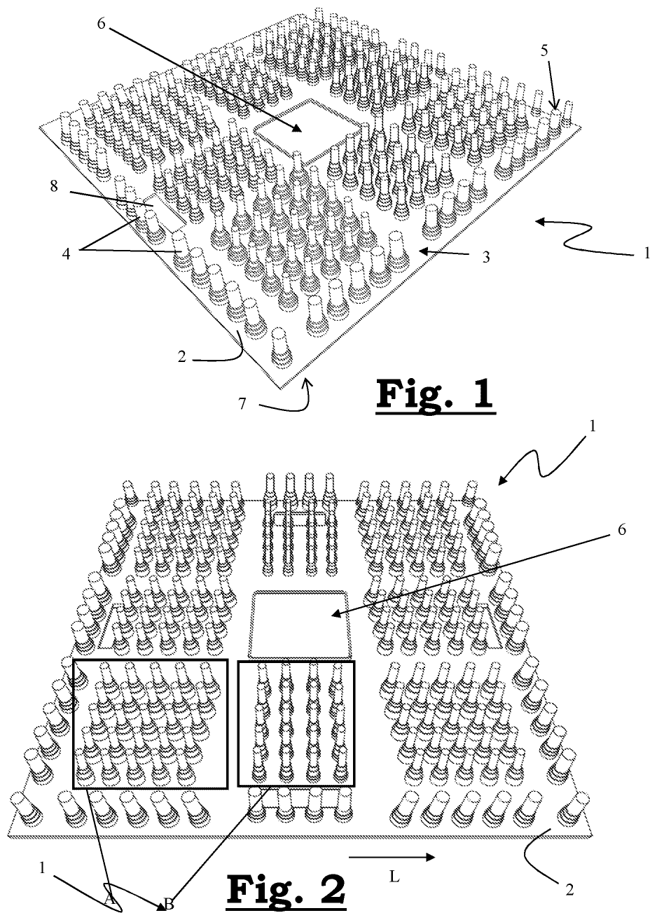

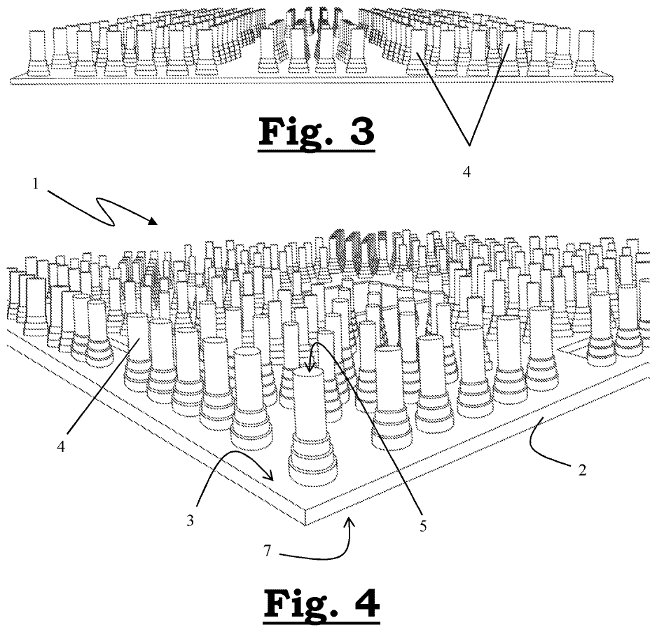

FIG. 1 shows a perspective illustration of a possible embodiment of the tile sawing mat according to the invention. In this exemplary embodiment, which is also shown in FIGS. 2 to 4, the tile sawing mat comprises a flexible, flat carrier body (carrier) having dimensions of about 80 cm×80 cm. The mat (1) has a first main surface (3) which forms the top surface of the carrier (2), and a second main surface (7) which is situated opposite the first main surface (3) and forms the bottom surface of the carrier. The bottom surface is flat. In a preferred embodiment, the bottom surface is provided with a specific design in order to prevent or at least limit the moving of the mat (1), during the use thereof. In practice, the thickness of the mat (1) is between 2 mm and 10 mm.

The tile sawing mat comprises a number of flexible support structures (4) which are preferably inseparably connected to the first main surface (3) and are provided according to a particular pattern.

The support structures (4) extend in a direction transverse to the first main surface (3). The support structures (4) are adapted in order to form, in use, a support surface for at least one tile element. In order to form a flat support surface for a tile element, the top surface (5) of the various support structures (4) is flat, as can be seen from the attached figures.

Furthermore, in a preferred embodiment, the support structures (4) are all of equal height. The support structures (4) have a minimum height of 35 mm and a maximum height of 100 mm. The height of the support structures is high enough that damage to the main surface by the rotating saw blade (cutting blade) of the cutting tool is avoided.

The support structures (4) in question are preferably also formed during the production of the tile sawing mat. The tile sawing mat is preferably formed via a pressing operation or by means of injection of a plastics compound into a matrix.

In the embodiment depicted, there is provided centrally in the tile sawing mat a square opening (6) having the following dimensions: 20 cm×20 cm. The opening (6) in question forms a space which will predominantly be used to saw specific surfaces or shapes from a tile element, without running the risk of damaging the support structure. In addition to this (central) opening (6), the mat (1) also has a second opening (8) having such a design that it is suitable for receiving part of the hand of the user of the tile sawing mat in question, and therefore the mat (1) can be easily grasped and moved.

Instead of or in addition to the aforementioned openings, the tile sawing mat (1) may be provided with one or more extraction openings (not depicted) through which dust, more specifically dust released during the sawing of tile elements on the tile sawing mat, can be discharged, preferably in the direction of an extraction installation. In practice, the tile sawing mat may be provided with a central extraction opening, such as a circular opening having a diameter of preferably between 30 mm and 300 mm, or with various passages through which the dust released can be discharged. Said passages are preferably perforations made through the flexible carrier having a diameter of preferably between 2 mm and 15 mm. The tile sawing mat may also comprise a combination of a central extraction opening and said various passages.

In practice, the base surface is greater than the top surface (5) for each support structure (4). A greater base surface provides better strength, whilst a smaller top surface (5) reduces the risk of the support structures (4) being damaged by a cutting tool. In the embodiment depicted, the support structures have a similar shape, namely stepped. The base surface of each support structure has a diameter of approximately 20 mm. There is a difference in top-surface diameter between the outer support structures located around the outer periphery and the other support structures. The diameter of the top surface of the outer support structures is approximately 12 mm, whilst the diameter of the top surface of the other support structures is approximately 8 mm. The outer support structures (4) have a greater top surface and are therefore wider and stronger; this is necessary because they are at a greater distance from each other than the other support structures.

A skilled artisan will recognize that the support structures may also have a different design, such as a conical design. A combination of different designs is also possible.

The tile sawing mat (1) according to at least one embodiment of the invention comprises, as illustrated in FIG. 2, at least a first (A) and second (B) set of support structures (4). Each set (A; B) comprises at least a number of rows of at least three support structures (4) extending in the longitudinal direction (L). The support structures (4) of the same set are located at a mutual centre-to-centre distance of 25 to 35 mm from each other. As can be seen from the attached figures, a free intermediate space is formed between the first (A) and second (B) set. This intermediate space is at least 60 mm wide, and preferably at least 65 mm wide. There are no support structures in this intermediate space. The intermediate space forms a sawing zone. The sawing zone is a space created to prevent the support structures from being damaged by the cutting tool during use of the tile sawing mat. During use, it is therefore important that the tile elements to be sawn are positioned on the support structures in such a way that the sawing line along which the tile element in question will be sawn through extends above a sawing zone of the tile sawing mat.

The various support structures together form a support surface for a tile to be cut. The support structures will also ensure that a tile will not move, when it is located on the support structures in question, during the sawing thereof. A mat (1) designed in this way makes it easy for a tile to be sawn to be sufficiently supported at a construction site so as to easily and rapidly saw said tile to the desired shape and/or to the desired size by means of a portable cutting tool, preferably a grinding disc.

The tile sawing mat according to at least one embodiment of the invention is preferably manufactured from any desired flexible material, with the preferred materials including rubber. In this case, both new and recycled rubber can be used for the production of the tile sawing mat. The tile sawing mat can be manufactured in any desired colour.

The tile sawing mat (1) according to at least one embodiment of the invention affords various advantages:
safe sawing of tiles using a separate grinding disc, maintains a flat underlying surface (which is always ensured by the identical height of the support structures and the waste that falls between the support structures);
good support for the tile elements to be sawn, which is always obtained due to the multiple support structures (4) present and the possibility of moving the tile until the correct support is found, and all this whilst being able to safely position the tile at a so-called sawing zone so that the support structure (4) is prevented from being damaged by the cutting tool;
for the use of another cutting tool, such as hole saws, there must be enough space between the support structures; hole saws come in various diameters. The largest hole saw that fits with a small model of grinding disc is 90 mm. This space is achieved by providing a suitable opening (6), preferably having minimum dimensions of 200 mm×200 mm, centrally.

The tile sawing mat according to at least one embodiment of the invention and as described above may form part of a tile support device (not depicted) suitable for supporting tile elements during the sawing thereof, wherein said device comprises at least the following:
a housing designed to receive a tile sawing mat;
a tile sawing mat according to the at least one embodiment of the invention;
and an extraction device which is coupled to the housing and is suitable for extracting dust released during the sawing of tile elements supported by the device.

The housing in question is preferably manufactured from plastic and comprises a bottom wall and upright side walls. A load-bearing structure is also provided to support the tile sawing mat. Such a load-bearing structure may, for example, be formed by support edges extending transversely, or virtually transversely, with respect to the side walls. Such a tile support device affords the advantage that it is much more pleasant and healthier to operate for the user thereof because the dust released will be immediately removed.

1. A tile sawing mat for supporting at least one tile element during the sawing thereof, comprising:
a flexible carrier having a first main surface; and
a plurality of flexible support structures connected to the flexible carrier,
wherein the plurality of flexible support structures extend in a direction transverse to the first main surface, and are adapted in order to form, in use, a support surface for at least one tile element,
wherein the plurality of flexible support structures have a height of at least 35 millimeters (mm) from the first main surface, measured in a direction transverse to the first main surface, to protect the first main surface against damage during sawing of the at least one tile element.

2. The tile sawing mat according to claim 1, wherein the height of the plurality of flexible support structures is at most 100 mm from the first main surface, measured in the direction transverse to the first main surface.

3. The tile sawing mat according to claim 1, wherein the tile sawing mat is manufactured from rubber.

4. The tile sawing mat according to claim 1, wherein the plurality of flexible support structures have the same height.

5. The tile sawing mat according to claim 1, wherein the top surface of the plurality of flexible support structures is flat.

6. The tile sawing mat according to claim 1, wherein said the plurality of flexible support structures are stepped or conical.

7. The tile sawing mat according to claim 1, further comprising at least a first and a second set of support structures in the plurality of flexible support structures, wherein each of the first set and the second set comprises a number of rows of at least three support structures extending in a longitudinal direction, wherein the support structures of the same set are located at a mutual center-to-center distance of 25 to 35 mm from each other.

8. The tile sawing mat according to claim 7, wherein a free intermediate space at least 60 mm wide, without support structures, is formed between the first and the second set, the free intermediate space forming a sawing zone for the sawing of the at least one tile element.

9. The tile sawing mat according to claim 1, further comprising one or more extraction openings through which dust released during the sawing of the at least one tile element supported on the tile sawing mat is discharged.

10. A tile support device for supporting at least one tile element during the sawing thereof, comprising:
a housing designed to receive the tile sawing mat according to claim 1, and
an extraction device which is coupled to the housing and is configured to extract dust released during the sawing of the at least one tile element supported by the tile support device.
